(19) United States
(12) Patent Application Publication
(10) Pub. No.: US 2008/0059437 A1
(43) Pub. Date: Mar. 6, 2008

(54) Data mining system

(76) Inventor: Rajehndra Yegappan Nagappan, Eveleigh (AU)

Correspondence Address: STETINA BRUNDA GARRED & BRUCKER, 75 ENTERPRISE, SUITE 250, ALISO VIEJO, CA, 92656, US

(21) Appl. No.: 11/899,204

(22) Filed: Sep. 5, 2007

(30) Foreign Application Priority Data
Sep. 5, 2006 (AU) 2006904852

(51) Int. Cl. G06F 17/30

(52) U.S. Cl. 707/3; 707/E17.014

(57) ABSTRACT

A method for data mining of at least one database by means of computer-implemented software; said method including the steps of: (g) creating at least one task defining Document for each of said at least one task, (h) defining within said Document a Business Rules diagram for said at least one task, (i) defining within said Document at least one Technical Operations diagram for implementation of Business Rules of said Business Rules diagram, (j) defining a Source Data icon indicating location of said at least one database or data file, (k) executing said Technical Operations with said Source Data to generate at least one output diagram, (l) verify that said at least one output complies with said Business Rules; and wherein each said diagram is a graphical rendition constructed by means of said computer-implemented software; each said diagram convertible to executable code adapted for processing by a central processor of a computer system.

The present invention relates to computer based systems for data manipulation and, more particularly, to processes sometimes known as data mining.

### BACKGROUND

Computers commonly store large amounts of data which contain inherent and latent relational patterns and which are potentially valuable in providing basis for managerial and operational decision making. Yet such data is often widely distributed within and amongst databases so that the extraction and use of such patterns and relationships is not readily available. Hence numerous data mining systems have been developed which seek to interrogate relevant databases using criteria to bring such relational patterns to light. However Data mining (DM) may be defined as discovering profile or behaviour patterns of customers, clients and other entities to better understand and subsequently better serve them in a more efficient or profitable manner. Transactions from databases are mined—i.e. amalgamated, sifted, probed and analysed—using specialist software. The ideal outcome is a set of business targets, such as a list of customers that you are currently at risk of losing and whom you must fight hard to maintain.

Data mining has had patchy success because it is hard to use, does not generate actionable results, and has poor cohesion to the business function that it is designed to serve. Data mining products use an archaic paradigm that reflects their research heritage, and data mining as a discipline has not developed pragmatic methods to decrease project risk. Taking each of these in turn:
Hard to use: current technologies focus on manipulation of a few technical details to the exclusion of other practical aspects. Users struggle to manipulate the software, often not understanding which operations they need to perform or how the controls fit into those tasks. Users are often not confident that the results yielded from the software are true or accurate, and they are hesitant to defend those results when challenged.
Does not generate actionable results: this is biggest single cause of data mining project failure. A manager will present some vague business objectives; the analyst will then take those away and perform some technical operations, injecting their own assumptions and inconsistencies. By the time the analyst returns with a result it bears little resemblance to what the manager intended or contains items that the business cannot do anything practical about.
Poor cohesion to the business function that it is designed to serve: over time the work performed with the data mining software becomes brittle, stale, irrelevant, or lost. People forget what they did, or inherit some work left by a departing staff member, and they have no idea how it works or what it does. The results that it generates have little connection to the main business of the department or company. The software, together with any preceding work, become idle, unused items.

It is an object of at least some embodiments of the present invention to address or at least ameliorate some of the above disadvantages.

Notes

1. The term “comprising” (and grammatical variations thereof) is used in this specification in the inclusive sense of “having” or “including”, and not in the exclusive sense of “consisting only of”.
2. The above discussion of the prior art in the Background of the invention, is not an admission that any information discussed therein is citable prior art or part of the common general knowledge of persons skilled in the art in any country.

### BRIEF DESCRIPTION OF INVENTION

Terminology: in this specification an Activity diagram is also known as a Transform diagram. A Relationship diagram is also known as a Match diagram.

Accordingly, in one broad form of the invention there is provided a method for data mining of at least one database by means of computer-implemented software; said method including the steps of:
(a) creating at least one task defining Document for each of said at least one task,
(b) defining within said Document a Business Rules diagram for said at least one task,
(c) defining within said Document at least one Technical Operations diagram for implementation of Business Rules of said Business Rules diagram,
(d) defining a Source Data icon indicating location of said at least one database or data file,
(e) executing said Technical Operations with said Source Data to generate at least one output diagram,
(f) verify that said at least one output complies with said Business Rules;
   and wherein each said diagram is a graphical rendition constructed by means of said computer-implemented software; each said diagram convertible to executable code adapted for processing by a central processor of a computer system.

Preferably said method includes the further step of defining within said Document data for a Test Rig diagram to satisfy said Business Rules.

Preferably said method includes the further step of verifying correct functionality by application of said at least one Technical Operations diagram to said data of said Test Rig diagram, and wherein each said diagram is a graphical rendition constructed by means of said computer-implemented software; each said diagram convertible to executable code adapted for processing by a central processor of a computer system.

Preferably said Document is composed by means of a user interface display generated on a display device linked to said computer and wherein descriptive and annotative text sections may be defined with said document.

Preferably said interface display comprises at least, a Document construction region, a Resource library region and a common productivity accessory region.

Preferably said Document construction region is adapted to accept a combination of text and “drag and drop” Resources accessed from said Resource library area.

Preferably one or more Resources are combined into a diagram in said Document construction region; each said diagram representing a subtask.

Preferably at least one said diagram is a Business Rules defining diagram.

Preferably at least one said diagram is a Technical Operations diagram.

Preferably said Technical Operations diagram may comprise an activity diagram, a relationship diagram or a combination of activity and relationship diagrams.

Preferably a technical operation diagram may link in other technical operations diagrams which will embed and execute together when the former is run.

Preferably said Test Rig diagram comprises a sample of input data and a sample of output data; said input data and said output data adapted to verification of one of said Business Rules and/or validation of one of said Technical Operations diagrams.

In a further broad form of the invention there is provided a computer-based data mining system wherein data mining is performed according to at least one user-defined rule for at least one associated data mining task; said system including a rule testing process wherein a sample of input data and a sample of expected output data are adapted to said at least one rule; said at least one rule implemented through a Document based diagram structure wherein each of at least one diagram of said diagram structure is translated into a computational process by said system.

Preferably said user-defined rule is a formulation of a characteristic of interest sought in Source Data for a data mining operation.

Preferably said system includes construction of Technical Operations diagrams; said diagrams including relationship and activity diagrams.

Preferably said relationship diagrams represent a user-defined relationship between sets of Source Data.

Preferably said activity diagrams represent user-defined processes applicable to said sets of Source Data.

Preferably each of said diagrams is constructed by a user in a Document; said Document provided as a user interface on a computer display.

Preferably said document is a readily interpreted corporate record of the business and technical steps involved that may be discussed, annotated, archived, reviewed, revised within the business operations.

Preferably each said diagram is translated by software of said data mining system into executable code for processing.

Preferably said user interface includes Libraries of Resources; said Resources including data mining operations and application activities.

Preferably said user interface includes productivity accessories; said accessories including calculator, a database diagnostic tool and statistical functions.

### BRIEF DESCRIPTION OF DRAWINGS

Embodiments of the present invention will now be described with reference to the accompanying drawings wherein:

FIG. 1A is a representation of a computer system for implementation of the data mining system of the present invention,

FIG. 1B is a flowchart of the basic steps of implementation of a preferred embodiment of a data mining operation according to the present invention,

FIG. 2 is a view of a user interface screen displayed on a personal computer of the computer system of FIG. 1,

FIG. 3 is an example of a document constructed in the user interface of FIG. 2,

FIG. 4 shows a list of diagrams associated with each of five data mining processes,

FIG. 5 shows a table for use in defining a set of rules for performing a data mining operation,

FIG. 6 shows a relationship diagram for implementation by the software of the data mining system,

FIG. 7 shows an activity diagram for implementation by the software of the data mining system,

FIG. 8 shows an example of a library of Resources for use in construction of the relationship and activity diagrams of FIGS. 6 and 7,

FIG. 9 is an example of a series of business rules for a data mining project entered into the table of FIG. 5,

FIG. 10 is a set of input data for use with a test rig,

FIG. 11 is a set of expected output data resulting from the operation of the test rig,

FIG. 12 is an example of an overarching project diagram for coordinating a number of subtasks in the data mining operation,

FIG. 13 is an example of a portion of a result table generated by the software of the data mining system according to the invention,

FIG. 14 is an example of an activity diagram in accordance with a preferred embodiment of the data mining system of the present invention.

### DETAILED DESCRIPTION OF PREFERRED EMBODIMENTS

In broad terms embodiments of the present invention comprise a document centred data analysis software system. Users develop data mining solutions by drafting conventional business documents containing text and tables that describe the business situation. They embed active data mining content containing queries that are run against their database to produce actual results for those situations. The document integrates business-focussed discussion and executable technical operations. The document is also a common language that allows analysts and managers to clearly communicate with each other about the task they are performing.

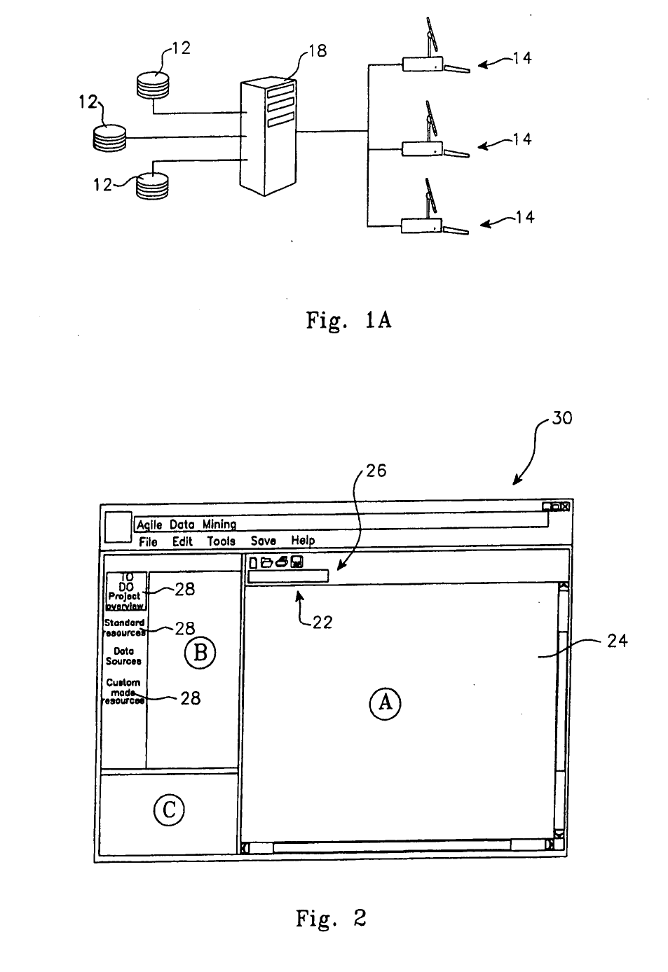

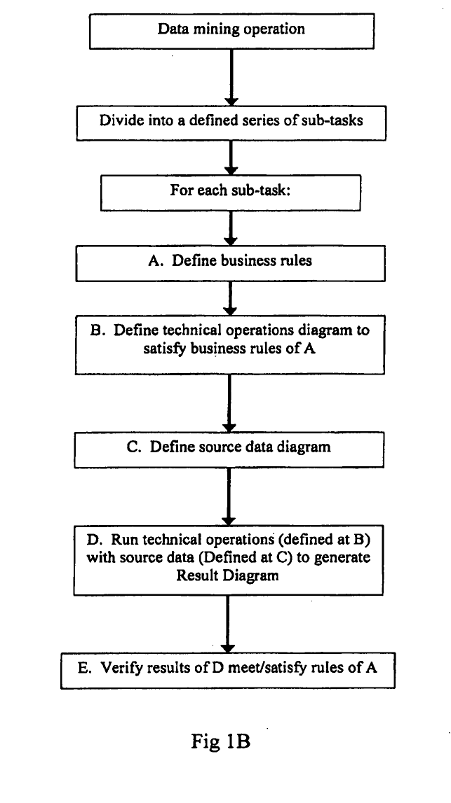

With reference to FIG. 1, a computer implemented system 10 for mining data from a variety of computer stored databases 12, includes at least one personal computer 14 interfaced with a server 16. The system includes a software application in which a user (not shown) is presented with a user interface 20, shown in FIG. 2, which permits the construction of sophisticated criteria and procedures for interrogating multiple data sources stored on the system.

Logically, a given data mining operation is divided into a number of subtasks. Each subtask may be defined in the following steps, to be explained in more detail below:
(a) define a Business Rules diagram for the subtask,
(b) Optionally define a Test Rig diagram to satisfy the Business Rules. This involves selecting input and expected output values,
(c) define Technical Operations diagram(s) to implement Business Rules. These are either transform or match diagrams,
(d) Optionally connect the Test Rig to the Technical Operations and run tests to verify correct functionality,
(e) define Source Data diagram—the location of actual data to be mined (which may be the output of other subtasks). These are either transform or match diagrams,
(f) run Technical Operations with Source Data to generate Results diagram(s),
(g) Verify that Results meet Business Rules.

Results generated by a given subtask may be used as input for the Business Rules of other subtasks. Transform and match diagrams may be reused as either operations or source data of other sub tasks.

Each defined subtask is identified by a subtask name 22 associated with a Document 24 which defines it. The name is displayed on a tab 26 of the user interface 20. A toolbar button (not shown) may be used to execute the Document constructed by the user by means of the user interface 20.

The term “Document” in this description refers to a conventional computer-based document which can include text and drag and drop icons.

With reference to FIG. 2, a user is provided with tools to construct a Document within the displayed user interface 20. The interface 20 is divided into three separate areas A, B and C. Area “A” is the working space in which the actual Document is constructed. Area “B” contains Libraries 28 containing icons representing Resources which may be accessed and dragged onto the Document construction area “A”. Area “C” is reserved for common productivity accessories including calculator, a database diagnostic tool and statistical functions. In an alternative preferred form the productivity accessories in Area “C” may be incorporated in a tab in the libraries area “B”. This is a tab on the libraries area in which several accessories are available:

Table calculator that performs operations whenever cells in a table on the document are selected. It computes the sum, minimum, maximum, count, standard deviation, range, etc of those selected cells.

Bookmarks list.

“To do” list.

List of currently running Diagrams with progress indicators and controls to cancel each one individually.

Resources

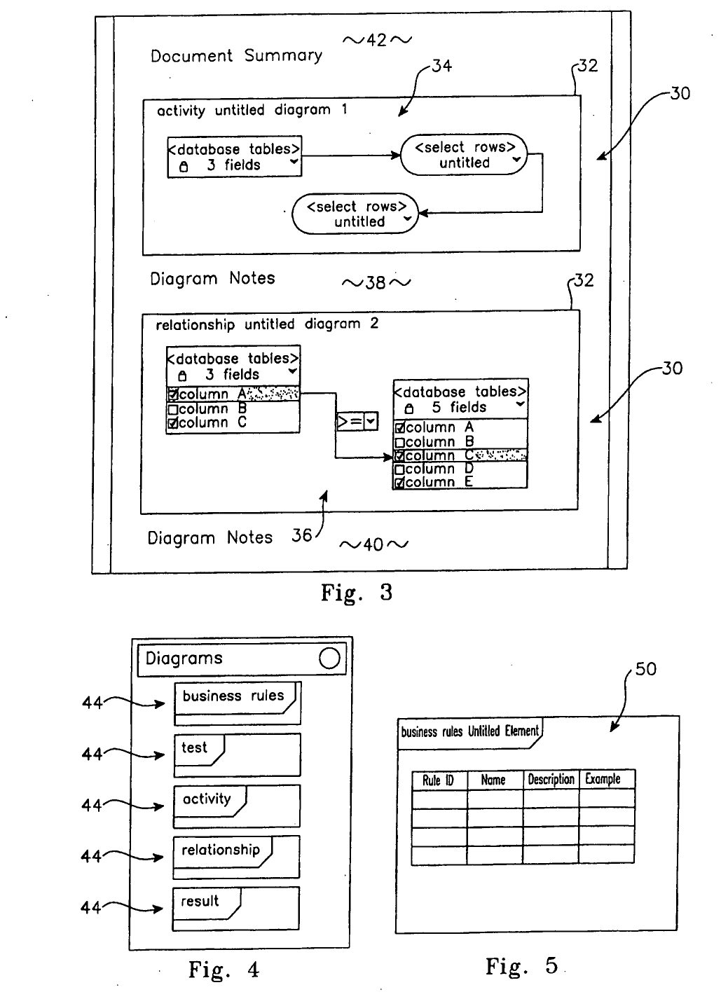

The Resources of area “B” include data processing operations, data mining algorithms, data tables and external information (variables) and other functions organized in Libraries of Resources represented diagrammatically by icons 28. Several Resources may be functionally linked together in the Document area A, to form a solution for a subtask. A user drags a selection of Resources from Libraries into a diagram 30 in the Document area A as shown in FIG. 3. Diagrams may then be linked by a “click-and-drag” process to form a complex useful function.

Each Resource has specific settings that define its operation and which can be accessed by the user by means of pop-up windows under the Resource icon. Settings may be displayed or hidden as desired.

Resources may also take the form of Templates which contain skeletal outlines of common business or other application situations. The user drags a selected Template into the Document area and fills in fields of the Template with his or her own data. Once on a Document, a Template can be edited to suit the user's particular requirements. A range of Templates may be provided with the data mining system to suit a variety of business and other data related applications.

Elements

1. Elements are building blocks. They have the following features. [image]
   a. Several elements are connected together on a Diagram to form a solution for a given small-scale problem or granular piece of the task.
   b. Elements is an umbrella term covering all runnable building blocks, including:
      i. Data processing operations
      ii. Data mining algorithms
      iii. Data tables from databases or text files
      iv. Parameters (variables)
      v. Reused Transform or Match Diagrams
   c. The user drags an Element from a Library onto a Diagram. Elements are then connected together by clicking-and-dragging between them. The Diagram combines several connected Elements into a complex, useful function.
   d. Each Element has specific settings that define its operation and the user can access these settings as a pop up window under the icon. Settings can be displayed or hidden under each Element as desired by the user.
      The Document Feature

The Document, which is a central feature of the present system will now be described in greater detail. As noted, it is a conventional Document which is constructed by a user using text and combinations of the Resources available from the Libraries in area B of the user interface to diagrammatically represent a particular business or other problem.

As shown in FIG. 3, each diagram 30 (representing an arbitrary number of such diagrams) is constructed in the Document in the form of a boxed field 32 and represents a particular executable task defining any of the five tasks denoted 44 in FIG. 4. Thus a diagram may contain a Technical Operation or a user-defined business rule or test rig or result. User-constructed diagrams which may be useful for future data mining operations within an organization, may be saved and added into a Defined Resource library. Diagrams of different types may be linked together within a Document to give more complex operations and criteria for mining than can be achieved within a single diagram.

HTML text can be inserted into the areas 38 and 40 between and below the diagrams 30 in the Document as shown in FIG. 3, to provide comments, explanations and contextual information. The text area 42 at the top of the Document may contain a summary of the overall subtask to be addressed by the Document.

More particularly:
a. Each document integrates several aspects.
   i. It is a conventional document which the user drafts and can be used as a business communication tool. It uses text, tables and drag and drop icons to diagrammatically represent the business problem. The document is a common language that allows analysts and managers to clearly communicate with each other about the task they are performing.
   ii. These diagrams are executed within Agile Data Mining® software as data mining code, producing actual results.
   iii. The modular arrangement of diagrams and HTML text areas within the document gives rise to an “executive summary+working details” layout in which business-centric diagrams and text are placed at the top of the document, and operation-centric diagrams and text are placed at the bottom.
   iv. Both linking executable diagrams and linking text through HTML hyperlinks (see (b) below) means that documents form a “web” of intertwined business context, runnable diagrams, and results, creating an integrated, multi-faceted solution to a complex business problem.
b. The physical structure of the document is:
   i. A user interface that appears as a series of pages that can be scrolled from top to bottom. The pages appear “joined” by dotted lines that mark the bottom of a previous page and the top of the subsequent page. The pages contain a vertical sequence of diagrams and HTML text areas.
   ii. Each diagram is indicated by a box border and constructed by dragging Elements (icons from libraries) onto the document construction area and connecting them together. Each diagram is a standalone artifact representing a specific Subtask within the overall project and may contain both technical operations and business rules.
   iii. These diagrams link with other diagrams to form conglomerations of tasks that eventually define the entire project. Diagrams may be additionally saved in the Custom Made Elements library. Diagrams of different types may be linked to each other, giving a broader and more flexible view than could be achieved with one diagram type alone. That is, two individual tasks can be concatenated by linking their diagrams. When executed the software will complete both tasks, with output data from the first task flowing as input data to the second task. There is no limit to the number of diagrams that can be linked in this way.
   iv. HTML text areas can be drag-and-dropped between Diagrams and at the top of the Document. The user types comments, explanations, and context information in these areas. The text area at the top of the Document is for holding a summary of the task that the whole document addresses. Text areas can be added under each diagram as necessary to hold explanations and notes specifically for that diagram, as well as HTML hyperlink cross references to other related diagrams and Documents.
c. Each document contains a Task, which is a self-contained unit of work for the project. There are six considerations to be taken into account when solving a data mining problem. These are:
   i. Business Rules: the business criteria that the task must meet. This aspect ensures that the work is relevant and usable for improving business operations.
   ii. Test Rigs: show that the task meets both business requirements and is correctly implemented. The tests specify concrete examples to compliment business rules. They also verify correctness of technical operations by showing that the solution works as expected.
   iii. Data transformation sequences: technical operations are arranged in a series of steps. For many data mining operations a sequence of calculations is the easiest way to work with the data.
   iv. Data matching between tables: technical operations are arranged as a set of tables with relationship connectors between them, e.g. field A equals field B. Often information from complex data structures is most easily extracted from this view.
   v. Results: output from technical operations is integrated into the document to show the eventual outcome of the work. The user visually relates the results to the above considerations to ensure that they are met.
   vi. Creating models from the data: this is the aspect of detecting higher-level behavioural characteristics using data mining modelling algorithms. Model building is seen as a distinct step compared to transforming and matching data—it generates a new model element compared to manipulating existing data. This is often thought of as a factory operation: submit data and pick up model.
d. Individual diagrams are used to address each of these considerations; they are described in the following paragraph.
e. There are six distinct Agile Data Mining® diagrams.
   i. Business Rules Diagram. [image]
      i. A table in which the user defines one rule per row. A business rule is a concise definition of a single specific business situation and optionally how to handle it, e.g. a high value customer is one who purchases more than $1000 per year. Rules are entered either as text or dragged from a previously defined rule (Templates library, Custom Made Elements library, or other diagram).
      ii. Initially used for planning and defining the scope of each document. This gives fine-grain business instructions, enabling accurate development of each Transform, Match or Model Diagram.
      iii. Provides a check facility for business relevance in that the user visually reconciles this table to the Test Rig, Transform, Match and Model Diagrams.
      iv. Provides a communication facility because both business managers and analysts use the Business Rules Diagram as a common artifact for discussion.
   ii. Match Diagram [image]
      i. Collection of data tables networked together to form a conglomerate data table. The user develops it by dragging tables from libraries or other diagrams.
      ii. Agile Data Mining® software executes this by translating it into a database query, carrying out the query, and returning the result as a conglomerate data table. The software performs the diagram-to-query translation internally, without user intervention. The software can execute match operations on tables from different databases or other data sources, ie. it can integrate data from disparate sources into a single table.
      iii. Used for collecting and joining all the data that the user wants to use for the particular problem. In turn this can be used as an atomic Element in other diagrams.
      iv. Provides an intuitive view of the data as tables joined by relationships.
   iii. Transform Diagram [image]
      i. A sequence of Elements representing a series of operations. The user develops it by dragging Elements and tables from libraries or other diagrams. At least one data table must be included to deliver a result, but an Activity Diagram without such a table can still be linked into other Test, Match, Model or Transform Diagrams.
      ii. Agile Data Mining® software executes this series by translating it into a nested database query, carrying out the query, and returning the result as data tables or visual charts. The software performs the diagram-to-query translation internally, without user intervention.
      iii. Used to execute technical data mining operations. In turn this can be used as an atomic Element in other diagrams.
   iv. Test Rig Diagram
      i. Diagram to test either an appropriate single Element or an appropriate single Technical Operation Diagram. It has four parts:
         a. Input data, which is a sample to be processed by the Element.
         b. Element under test.
         c. Expected output data, manually computed and entered by the user, or copied and pasted.
         d. Actual output data.
      ii. Agile Data Mining® software executes the test by running the Element with the given input data and comparing the actual output data produced against the expected output data. Differences between actual and expected outputs are reported to the user.
      iii. Test Diagrams are used only for checking that operations work as intended. (Checking accuracy of data mining algorithms is an analysis task, not a testing task, and is performed in technical operations diagrams as per other operations.) This diagram provides assurance of work for both technical correctness and compliance to business rules
   v. Result Diagram
      i. A graphical display of data tables, predictive models, and visual charts that are computed by Transform or Match Diagrams. It is generated on the same document that contains the corresponding Transform or Match diagram.
      ii. Dependant on the output type, the user can interact with these outputs in a variety of context-sensitive ways. Eg. Highlighting table rows or zooming into regions on charts.
      iii. Results are used for visual interpretation and analysis, as well as being an integral part of the reporting mechanism for the project.
   vi. Model Building Diagram
      i. A diagram to construct predictive models. Data is input either by dropping a database table or by linking a Match or Transform Diagram. The user can select from several industry-standard data mining predictive algorithms and set various parameters to control the model building process.
      ii. Using the input data and the set parameters, this Diagram will generate a Predictive Model Element and statistics relating to the model's accuracy. Predictive Model Element generation is an industry-standard algorithmic learning process.
      iii. The user drags the Predictive Model Element into a separate Transform Diagram to make predictions on other unseen data.
To execute a diagram, select its name from the Execution drop down list on the document construction toolbar and press the “execute” button (an arrow much like a media play button). This will then cause the software's engine to translate and run the diagram, linking in other diagrams as required, and to generate any results on the document.
f. Templates contain skeletal outlines for common business situations. The user drags a template onto a document and fills in the blanks with their own data. Once on a document the template can be altered to suit custom situations. Templates will be made available for different industries and different business processes.
   Libraries
a. Libraries contain icons which represent Elements used to draft each Agile Data Mining® document. [image]
   i. The Elements within a Library are displayed within one or more groups. Each group is shown using the title and frame as above. The group can be expanded as shown or collapsed to display the title only. The groups are stacked vertically within the Library.
   ii. The following libraries are available
      i. Project Overview—contains Elements for diagrams and documents already drafted for the current project.
      ii. Standard Elements—contains Elements for the standard building blocks that ship with the software. They represent data mining operations and business activities.
      iii. Custom Made Elements—contains Elements for building blocks custom made by the user that can be utilised in future work.
      iv. Data Sources—contains Elements for database tables, spreadsheets and files where source data resides.
      v. Templates—contains Elements for pre-assembled solutions for common business problems that the user can customise.
      vi. Clipboard—an empty space that can be used to temporarily store work.
   iii. To use an Element, drag it from the appropriate Library to the Document being constructed. The software creates either a new copy on the Document or a link to the original instance as appropriate. The user can specify whether to link or copy some types of Element in certain situations.
   iv. The user can save a Diagram as a reusable Element by dragging it from the Document to the Custom Made Elements Library. This creates a copy of the Element in that Library, and is available for use in the usual manner.
   v. Libraries can be searched. A search box is contained at the top of the library, where the user can type text to match against. There are also several options to determine criteria: how to match the text and what to match it against. Erasing the text from the search box makes it inactive. Typing text or clicking the options make it active; the search is recalculated after every keystroke or click. [image]
      Process

Five considerations may be taken into consideration in solving a data mining subtask according to the invention;
(a) Business Rules: these are the criteria that the subtask must meet and are formulations of some characteristic of interest sought in the Source Data.
(b) Test Rig: a testing arrangement to indicate that the subtask meets the criteria set by the Business Rules and is correctly implemented. The tests include data samples able to satisfy the criteria and allow verification of correct execution of the Technical Operations.
(c) Activity Sequences: these are Technical Operations performed by the software in a series of steps, for example as a series of calculations.
(d) Relationships between tables: Technical Operations are arranged as a set of tables with relationship connectors between them; for example field A of a table X is equal to field B of a table Y.
(e) Results: output from the Technical Operations is integrated into the Document to show the eventual outcome. A visual inspection is made to ensure that the expected outcome of the Test Rig sample data has been correctly achieved by the subtask process.
   Data Mining Diagrams

Each of the above considerations is met by five associated diagrams 44 as illustrated in FIG. 4. These are a permanent part of the parent Document whilst this is resident on the computer system, but may be exported for subsequent use, for example as embedded in reports for business communication.

The Business Rules Diagram (FIG. 5)

The Business Rules Diagram comprises a table 50 in which the user defines one rule per row. Columns provide details of the actual rule, the name of the rule, description and an example. A rule may be entered as text or as a Resource selected from one of the Libraries as described above.

The diagram provides a tool for planning and defining the scope of each Document. This gives fine-grain criteria related instructions, enabling accurate development of each Activity or Relationship diagram. It further provides a check facility of relevance to the set criteria of the Business Rules in that the user can visually reconcile the table to the Test Rig diagram and the Activity or Relationship diagrams.

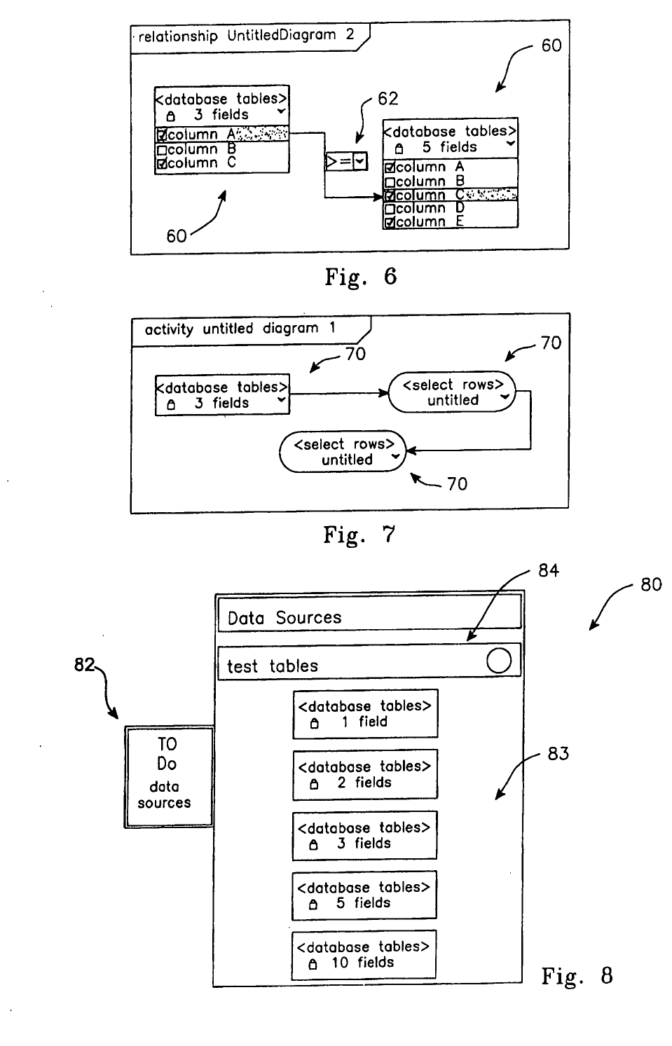

The Relationship Diagram (FIG. 6)

This provides for a collection of tables 60 (database entries) networked together to form a conglomerate data table. It is constructed by the user by dragging tables from Libraries or from other diagrams linking them by relationship functions 62. The software of the system translates the diagram into a query, executing it and returning the result in a conglomerate data table. The diagram to query translation is functionally performed by the software without user intervention.

The Relationship Diagram is used for collecting and joining all the databases that the user wishes to interrogate for obtaining the solution to a particular data mining problem. It in turn can be used as a Resource in other diagrams. Furthermore it provides a visual intuitive view of the data tables and their connecting functional relationships.

The Activity Diagram (FIG. 7)

An Activity Diagram represents a series of operations 70 and is developed by the user by dragging into the Document Resources and tables from Libraries and other diagrams. At least one data table must be included to return a result although an Activity Diagram without a table may still be linked to Test Rig Diagrams, Relational or Activity Diagrams.

The Activity Diagram is executed by the data mining system software after translation into a computation, returning the result as data tables, predictive models or visual charts. Again the software performs the diagram to computation translation internally, requiring no user intervention.

The Activity Diagram executes the required data mining operations, with the derived output available for use as a Resource in other diagrams if desired.

The Relationship Diagrams and Activity Diagrams are characterised as the Technical Operation Diagrams of the data mining system.

The Test Rig Diagram

This diagram is used to test either an appropriate single Resource or a single Technical Operation Diagram. It comprises four parts:
(a) input data; data structured by the user to reflect the type and characteristics of data to be retrieved by the data mining process,
(b) the Resource or Technical Operation under test,
(c) expected output data; this is manually derived by the user from the input data by applying the functions of the Business Rule as expressed in the Resource or Technical Operation.

The system software executes the test by running the Resource or Technical Operation Diagrams with the given input data and comparing the result with the expected output data. Discrepancies between the actual output and expected output are reported to the user.

Note that the Test Rig Diagram is only used to assess the correct operation of the data mining system for a given problem. Actual checking of the accuracy of data mining algorithms is an analysis task, not a testing task and is performed in Technical Operations Diagrams as per other operations. The Test Rig Diagram and its execution provide assurance of work for both technical correctness and compliance with the criteria of the Business Rules.

Result Diagram

A Result Diagram is a graphical display of data tables, predictive models and visual charts that are computed by Technical Operations or Relationship Diagrams. It is generated on the same Document which contains the corresponding Operations or Relationship Diagram.

Depending on the type of output, the user can interact with the Result Diagram in a variety of context related ways. Results are used for visual interpretation and analysis, as well as providing an integral part of the reporting process for the data mining project.

Libraries

As noted above, Libraries contain a variety of Resources represented by icons, which may be used to construct a data mining Document. With reference to FIG. 8, a Resource 83 from a Library 80 is accessed via icon 82. The Resources within a Library are displayed within one or more groups. Each group is shown using the title 84 and frame as shown in FIG. 8. The group can be expanded (as in FIG. 8) or collapsed to show the title only. Groups may be stacked vertically within the Library.

Available Libraries

(a) Project Overview: contains Resources for diagrams and Documents already constructed for the current project.
(b) Standard Resources: contains Resources for the standard building blocks that ship with the data mining software. They represent data mining operations and application activities.
(c) Custom Made Resources: contains Resources for building blocks custom made by the user and saved for use in future data mining exercises.
(d) Data Sources: contains Resources for database tables, spreadsheets and files where Source Data resides.
(e) Templates: contains Resources for pre-assembled solutions for common business and other application problems which can be customised by the user.
(f) Clipboard: an empty data storage facility which can be used to temporarily store work.

To use a Resource, it is dragged from the appropriate Library to the Document under construction. The data mining software of the system creates either a new copy on the Document or a link to the original instance of the Resource as appropriate. The user is enabled to specify whether to link or copy some types of Resources in certain situations.

A user-constructed Diagram can be saved as a re-usable Resource by dragging it from the Document to the Custom Made Resources Library. This creates a copy of the Resource in that Library and is available subsequently in the normal manner.

In Use

The data mining system of the present invention may be used in a variety of environments where data retained in various databases can provide bases for management decisions, if the various relationships and patterns inherent in the data could be extracted according to user defined criteria.

As an example, a sales and marketing department wishes to analyse its databases relating to its customers, to ascertain why the company is losing some customers while retaining others. The databases may include the customer list, sales databases and billing database, all maintained on the company's computer system server.

The object of the data mining exercise is to identify those customers the company is at risk of losing. Typically, the user of the data mining software for a data mining exercise will be a data analyst who will work with sales and marketing staff and management to divide the objective into a number of loosely defined subtasks comprising smaller workable sections. These may comprise:
(a) Identify “all valuable customers” worth saving,
(b) Identify those customers already lost to the company,
(c) Create a profile for lost customers,
(d) Match the lost customer profile against “all valuable customers”.

Each of these subtasks may be addressed by the data mining software resident on the company's server. The first subtask, that of identifying all customers worth saving, may be solved as follows.

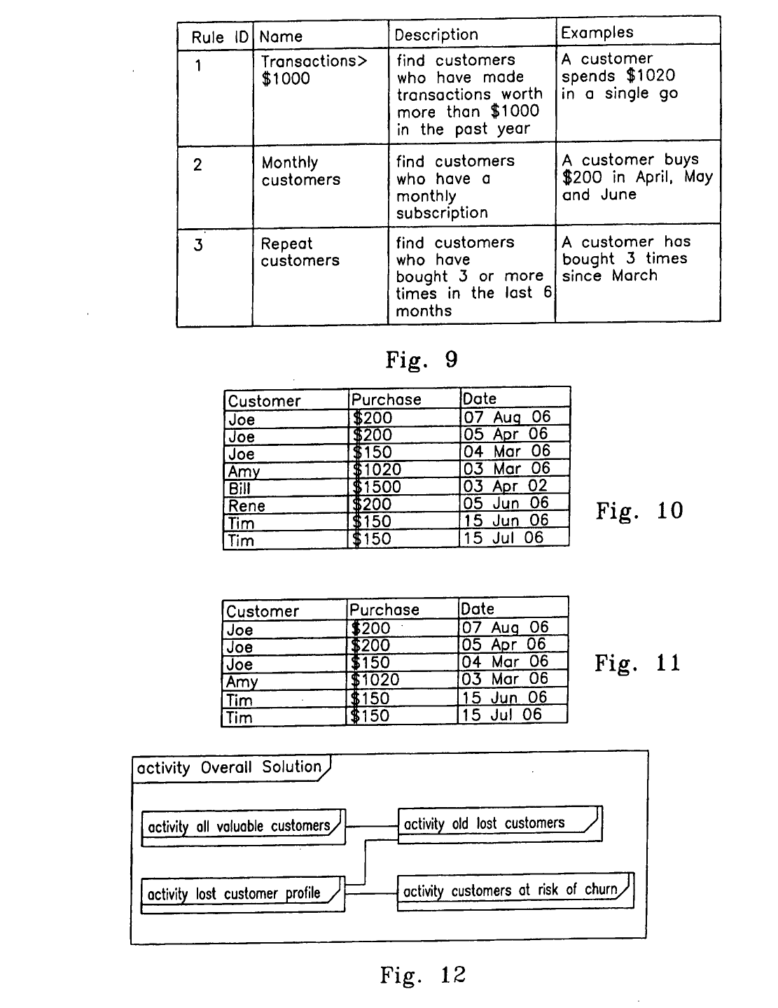

The analyst creates a new Document by “clicking” a New Document icon on the toolbar of the user interface. The analyst, staff and management then determine the Business Rules to be applied to the subtask. These could be “find those customers who have made transactions greater than $1000 in the past year”; “find those customers who buy at least once a month”; find those customers who have made three or more transactions over the past 6 months”. These Rules can be tabulated as shown in FIG. 9.

The analyst now creates on the Document, one or more Test Rig Diagrams (Input Data and Expected Result Data) as shown in FIG. 10, which contain sample data structured to satisfy the tabulated Rules. That is, if the Rules are correctly realized in the to-be-constructed Technical Operation Diagrams, the Input Data should yield the Expected Output Data shown in FIG. 11.

The formulation of the Business Rules and Test Rig Diagrams may be an iterative process mediated between the analyst and management until both are satisfied that these will capture the objectives of the data mining exercise.

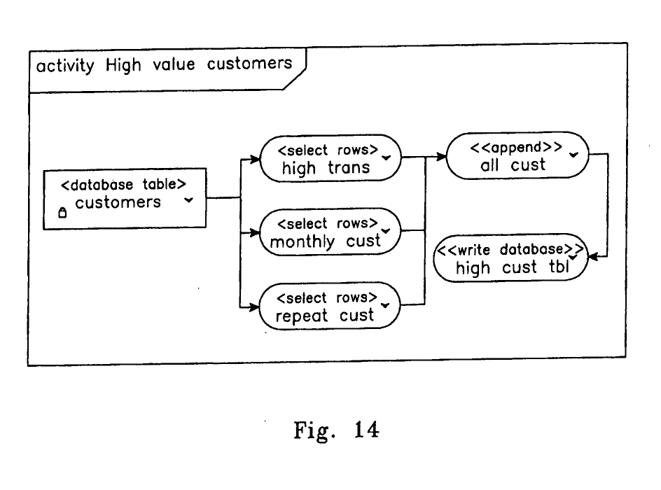

The analyst now constructs the required Technical Operation Diagrams, (Activity and/or Relationship Diagrams) which implement the functionality set out in the Business Rules and Test Rig Diagrams. For this example, an Activity Diagram addressing the first task “identify all valuable customers worth saving” would appear as shown in FIG. 14.

The analyst now operates the data mining software to apply the Technical Operation Diagrams to the Test Rig data to verify that the operations yield the correct expected outputs. If required, the Technical Operation Diagrams can be modified until the correct outputs are achieved.

Once satisfied that the Technical Operation Diagrams operate correctly on the Test Rig data, the data mining process on the organization's actual customer databases can be initiated with confidence that the output thus obtained conforms to the object of the exercise. The resultant output may take the form of tables, charts or combinations of these.

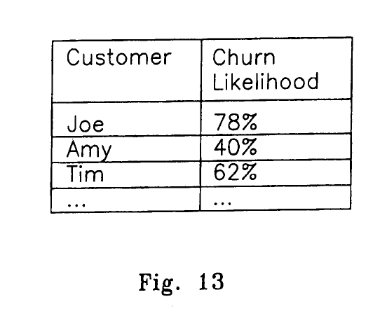

A new Document is created for each of the remaining subtasks identified with suitable Business Rules, Test Rig Diagrams and Technical Operations Diagrams as described for the first subtask. The final data mining solution is the combination of all the subtask Documents into a single overarching Document that executes each subtask in sequence. For this example such an overarching project Document would coordinate subtasks as shown in FIG. 12, with a final output in this example, taking the form of the table shown in FIG. 13.

Although the above description is set in a business context it should be noted that the data mining system of the present invention can be applied to other than business problems. Thus for example in an engineering application the “rules” may comprise various engineering outcomes such as tolerances and surface finishes to be achieved by various methods and available machinery, or stress and performance characteristics of various materials for example.

Software Background

The above described preferred embodiments may be implemented by suitable programming of data processing equipment as follows:
The application is a graphical Java application. The software is distributed on CD and installed on the user's computers. No internet-based service is provided as part of the core software.
The application communicates with external databases using standard software connectors.
The application communicates with databases over the network. The user does not interact directly with the database. Data analysis is executed by the application.
The business process is tightly integrated with the software's capabilities.
The application is installed on the desktop computer of each user.

In alternative forms at least some of the software components can be provided as embedded firmware on purpose built circuit boards.

The above describes only some embodiments of the present invention and modifications, obvious to those skilled in the art, can be made thereto without departing from the scope and spirit of the present invention.

1. A method for data mining of at least one database by means of computer-implemented software; said method including the steps of:
a) creating at least one task defining Document for each of said at least one task,
b) defining within said Document a Business Rules diagram for said at least one task,
c) defining within said Document at least one Technical Operations diagram for implementation of Business Rules of said Business Rules diagram,
d) defining a Source Data icon indicating location of said at least one database or data file,
e) executing said Technical Operations with said Source Data to generate at least one output diagram,
f) verify that said at least one output complies with said Business Rules;
and wherein each said diagram is a graphical rendition constructed by means of said computer-implemented software; each said diagram convertible to executable code adapted for processing by a central processor of a computer system.

2. The method of claim 1 comprising the further step of defining within said Document data for a Test Rig diagram to satisfy said Business Rules.

3. The method of claim 1 comprising the further step of verifying correct functionality by application of said at least one Technical Operations diagram to said data of said Test Rig diagram.

4. The method of claim 1 wherein said Document is composed by means of a user interface display generated on a display device linked to said computer and wherein descriptive and annotative text sections may be defined with said document.

5. The method of claim 4 wherein said interface display comprises at least, a Document construction region, a Resource library region and a common productivity accessory region.

6. The method of claim 5 wherein said Document construction region is adapted to accept a combination of text and “drag and drop” Resources accessed from said Resource library area.

7. The method of claim 5 wherein one or more Resources are combined into a diagram in said Document construction region; each said diagram representing a subtask.

8. The method of claim 1 wherein at least one said diagram is a Business Rules defining diagram.

9. The method of claim 1 wherein at least one said diagram is a Technical Operations diagram.

10. The method of claim 9 wherein a said Technical Operations diagram may comprise an activity diagram, a relationship diagram or a combination of activity and relationship diagrams.

11. The method of claim 10 wherein a technical operation diagram may link in other technical operations diagrams which will embed and execute together when the former is run.

12. The method of claim 2 wherein said Test Rig diagram comprises a sample of input data and a sample of output data; said input data and said output data adapted to verification of one of said Business Rules and/or validation of one of said Technical Operations diagrams.

13. A computer-based data mining system wherein data mining is performed according to at least one user-defined rule for at least one associated data mining task; said system including a rule testing process wherein a sample of input data and a sample of expected output data are adapted to said at least one rule; said at least one rule implemented through a Document based diagram structure wherein each of at least one diagram of said diagram structure is translated into a computational process by said system.

14. The system of claim 13 wherein a said user-defined rule is a formulation of a characteristic of interest sought in Source Data for a data mining operation.

15. The system of claim 13 wherein said system includes construction of Technical Operations diagrams; said diagrams including relationship and activity diagrams.

16. The system of claim 15 wherein said relationship diagrams represent a user-defined relationship between sets of Source Data.

17. The system of claim 15 wherein said activity diagrams represent user-defined processes applicable to said sets of Source Data.

18. The system of claim 13 wherein each of said diagrams is constructed by a user in a Document; said Document provided as a user interface on a computer display.

19. The system of claim 18 wherein said document is a readily interpreted corporate record of the business and technical steps involved that may be discussed, annotated, archived, reviewed, revised within the business operations.

20. The system of claim 13 wherein each said diagram is translated by software of said data mining system into executable code for processing.

21. The system of claim 13 wherein said user interface includes Libraries of Resources; said Resources including data mining operations and application activities.

22. The system of claim 13 wherein said user interface included productivity accessories; said accessories including calculator, a database diagnostic tool and statistical functions.
